(19) United States
(12) Patent Application Publication
(10) Pub. No.: US 2026/0261547 A1
(43) Pub. Date: Sep. 3, 2026

(54) METHOD AND SYSTEM FOR COMMUNICATION VIA A CELLULAR COMMUNICATION DEVICE VIA A SECURE USER INTERFACE

(71) Applicant: CONCERAS, LLC, Fairfax, VA (US)

(72) Inventor: Joseph Cole, Box Elder, SD (US)

(21) Appl. No.: 19/659,412

(22) Filed: Apr. 27, 2026

Related U.S. Application Data
(63) Continuation-in-part of application No. 18/660,488, filed on May 10, 2024.
Application No. 18/660,488 is a continuation-in-part of application No. 18/199,234, filed on May 18, 2023, now Pat. No. 12,323,387.
(60) Provisional application No. 63/622,395, filed on Jan. 18, 2024.

(51) Int. Cl. H04L 9/40; H04B 10/27

(52) U.S. Cl. CPC H04L 63/062; H04B 10/27

(57) ABSTRACT

Methods, devices, and systems allow a user to utilize their portable communication device from within a secure area, preferably via a secure user interface that is communicatively coupled to their device which is located outside of the secure area. The system includes a communication interface located outside of the secure area which serves as an interface to the user communication device, and which communicates with a secure user interface within the secure user interface by one or more communication isolators that transmit information between the secure and unsecure areas via optical communication signals. The secure user interface includes secure user input and/or out devices such as a touch screen display, speaker, microphone and keyboard for presenting outputs and receiving inputs in a manner that mimics direct interaction with the user communication device.

### RELATED APPLICATION DATA

This application is a continuation-in-part of U.S. Application Serial No. 18/660,488, filed May 10, 2024, which claims priority to U.S. Provisional Patent Application Serial No. 63/622,395, filed Jan. 18, 2024, and which is a continuation-in-part of U.S. Application Serial No. 18/199,234, filed May 18, 2023, now U.S. Patent No. 12,323,387. The present application incorporates by reference each of said prior applications as if set forth fully herein.

### FIELD OF THE INVENTION

The present invention relates to communication devices and systems, and particularly those which include the use of wireless devices in association with secure spaces.

### BACKGROUND OF THE INVENTION

With cell phones becoming ubiquitous in our everyday lives, a unique problem arises in the Military and Government sector where cell phones are not allowed in controlled or secure spaces where secure (proprietary, classified, etc.) information is processes and discussed. These restrictions limited a person’s ability to function at the workplace, in that most employees heavily rely on their cell phones because they store important information (contacts lists, photographs, etc.), serve as a communication interface for calls, texts and emails, VoIP telco, social media communications applications such as WhatsAPP, FaceBook Messager, and operate important applications such as home security interfaces, web browsers, etc. Similar restrictions may even be imposed in the civilian space, such as in sensitive areas where protection of trade secrets and other highly confidential information is desirable.

Generating a solution to address the problems that are created because a user’s cell phone can’t be brough into such a secure area is, however, difficult. This is in part because of the numerous security-related requirements and objectives which prevent a user from bringing their phone into the secure space.

For example, for security purposes, no device which emanates a radio frequency (RF) signal is allowed into controlled spaces—which includes not only cellular signals, but WiFi, Bluetooth, near field (NF) and other RF technologies. This prevents, for example, a solution in which the user leaves their phone outside of the secure space but then links to it from a device within the space via such wireless protocols.

A user is also prevented from bringing their phone into such a space because the phone could potentially be tampered with to include a separate device “bug” to send a signal outside the controlled space. Thus, the user’s phone can’t be brought into the space even if the wireless communications thereof are not utilized—effectively removing the ability to utilize any device in the secure space which can communicate wirelessly.

Communications signaling via wired (e.g. copper) connection outside these spaces are also forbidden as it creates a security issue in that it could potentially acts as an antenna to shunt a radiated signal intended to remain in the secure area and providing a means of sending that signal out.

Communication devices contained within these controlled workspaces must also be secured relative to the user interface features thereof. For example, no cameras are allowed in these space, and measures must be taken to ensure the microphone and or speaker of any device can’t be accessed to remotely eavesdrop on the secure space.

A solution to these problems is desired.

### SUMMARY OF THE INVENTION

Aspects of the invention comprise methods, devices and systems which allow a user to utilize their cellular communication device from within a secure area (including to use their communication device as an interface to one or more other devices, such as one or more third party systems or devices), via a secure user interface that is communicatively coupled to their device which is located outside of the secure area via an isolated methodology.

One embodiment of the invention comprises a system facilitating secure communications with a user communication device from a secure area comprising a first communication isolator for location in the unsecure area, the first communication isolator comprising a first communication port for connection to a communication port of the user communication device, a second wired communication port for wired communication coupling the user communication device to at least one third party system or device via the first communication port, and at least one optical communication port, a second communication isolator for location in a secure area, the second communication isolator comprising at least one optical communication port for connection to the at least one optical communication port of the first communication port to permit communications between the first and second communication isolators via a secure optical communications channel, the second communication isolator further comprising at least one user interface communication port,; and a secure user interface for location in the secure area, the secure user interface comprising at least one communication port for connection to the at least one user interface communication port of the second communication isolator, the secure user interface comprising a video display having touch input, at least one speaker and at least one microphone, whereby outbound communications based upon user inputs to the secure user interface are transmitted to the at least one third party system or device via the secure optical communications channel and the user communication device and inbound communications from the at least one third party system or device are transmitted to the secure user interface via the user communication device and the secure optional communications channel.

Another embodiment of the invention comprises a method of facilitating secure communications to and from at least one third party system or device outside of a secure area and a user in a secure area via a user communication device outside of the secure area, comprising the steps of: receiving, at a first communication isolator located outside of the secure area, an inbound communication from the at least one third party system or device via the user communication device, converting the inbound communication to at least one first optical signal, transmitting the at least one first optical signal from the first communication isolator to a second communication isolator located in the secure area via at least one optical communication link, presenting the inbound communication via a user interface located in the secure area and communicatively coupled to the second communication isolator, receiving an outbound communication based upon one or more user inputs to the user interface at the second communication isolator, converting the outbound communication to at least one second optical signal, transmitting the at least one second optical signal from the second communication isolator to the first communication isolator via the at least one optical communication link, and transmitting the outbound communication to the at least one third party device or system via the user communication device located outside of the secure area.

Further objects, features, and advantages of the present invention over the prior art will become apparent from the detailed description of the drawings which follows, when considered with the attached figures.

### DESCRIPTION OF THE DRAWINGS

FIG. 1 illustrates one embodiment of a system of the invention;

FIG. 2 illustrates an embodiment of a secure user interface of a system of the invention;

FIG. 3 illustrates an embodiment of a portion of the secure user interface illustrated in FIG. 2;

FIG. 4 illustrates another embodiment of a portion of the secure user interface illustrated in FIG. 2;

FIG. 5 illustrates an example implementation of the portion of the secure user interface illustrated in FIG. 4;

FIG. 6 illustrates another embodiment of a system of the invention;

FIGS. 7A and 7B illustrate yet another embodiment of the invention; and

FIG. 8 illustrates yet another embodiment of a system of the invention.

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

Aspects of the invention comprise methods, devices and systems that allow a user in a secure area to access one or more communication or computing devices in an unsecure area. In one embodiment, the communication device comprises a user’s mobile (e.g. with wireless communication capability such as cellular, WiFi, etc.) communication device and the method and method permit a user to access their communication device from within a secure area, preferably via a secure user interface that is communicatively coupled to their device which is located outside of the secure area.

As used herein, the term “secure area” or “controlled area” may be any area in which there are restrictions on the use of communication devices, such as cellular phones. As noted above, such areas might comprise military or government installations or other areas where the laws and regulations regarding the security of information apply. These areas might also comprise, however, sensitive areas of corporate offices or manufacturing plants, etc.

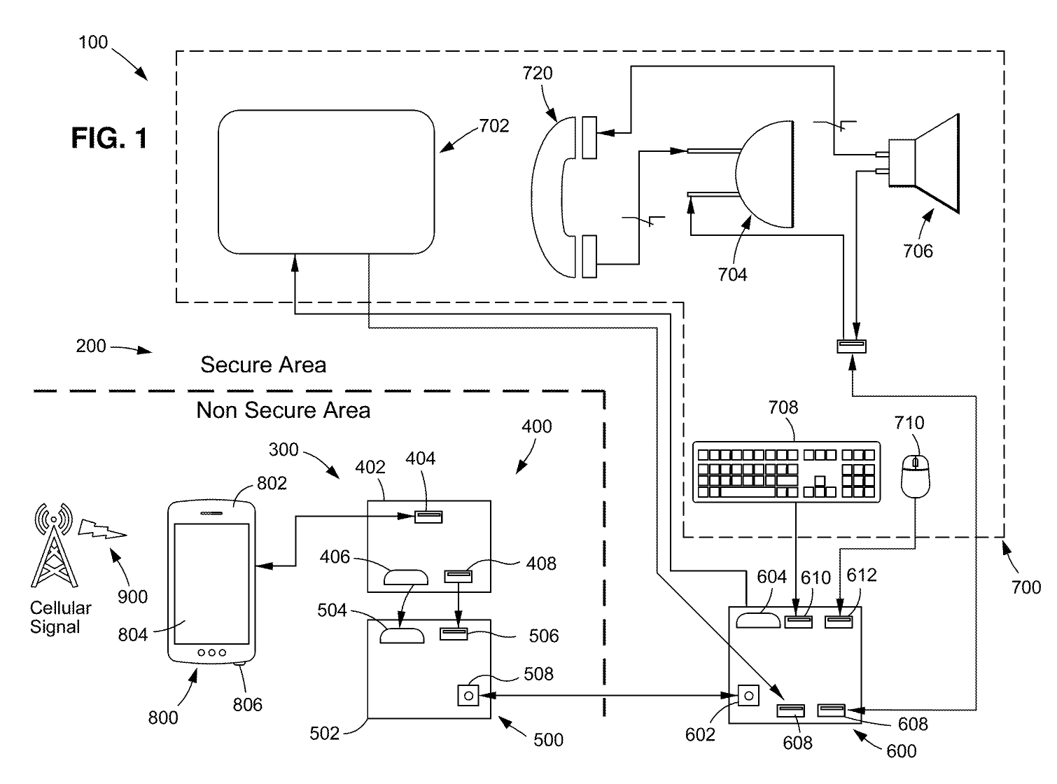

One embodiment of the invention will be described with reference to FIG. 1. FIG. 1 illustrates one example of a system 100. The system 100 includes components which are located within a secure area 200 and includes components which are located outside of the secure area, which area may be referred to as an unsecure or non-secure area 300. As indicated above, the type and location of the secure area 200 may vary, and might comprise a government building, military installation, corporate office, etc. The non-secure area 300 may comprise a public space or a private space, such as a portion of the government building, military installation, corporate office or the like which is outside of the secure area 200 (and not within another secure area).

In one example, the system 100 comprises a communication device interface 400, a first communication isolator 500, a second communication isolator 600, and a secure user interface 700.

In a preferred embodiment, the communication device interface 400 comprises a communication interface to a user communication device 800. As described below, in use, the user communication device 800 is located in the non-secure area 300. The communication device interface 400 is thus also located in this same area.

The user communication device 800 may comprise, for example, a cell phone, PDA, tablet or the like which supports communication functionality. The user communication device 800 may include a housing 802, processor, a memory, machine-readable code stored in the memory and executable by the processor (such as in the form of downloaded or installed “applications”), one or more user input devices (such as a touch screen, button(s), microphone, etc.), an information display 804 (such as at least one video display) and one or more peripheral devices, such as a camera, gyroscope, speaker, altimeter, GPS unit, etc.

Moreover, the user communication device 800 includes at least one communication interface. The at least one communication interface preferably supports wireless communications, preferably over at least a cellular network 900, and may permit other forms of communication, such as Wi-Fi, Bluetooth, near field (NF) and other forms of wireless communication, plus wired communications. Such wired communications may be, for example, via a port 806. The configuration of the port 806 might vary, such as depending upon the communication device 800. For example, the port 806 might comprise an Apple® Lightning™ connection port, a USB Type A, Type C, Mini B, Micro B, Micro B Super Speed, ports of other configurations now known or later developed for establishing a wired communication link. The user communication device 800 may comprise, for example, an Apple® iPhone™ device, an Android™-based communication device such as a Samsung® Galaxy™, a Motorola® Razor™, or various other communication devices now known or later developed and which may be produced or provided by various manufacturers. In this regard, the present invention is not limited to any particular device, or the devices manufactured by a particular manufacturer.

In one embodiment, the communication device interface 400 comprises a housing 402 and one or more communication interfaces, such as input/output (I/O) ports. For example, the communication device interface 400 may include at least a first I/O port 404 which serves as a communication interface to the user communication device 800. The configuration of the first I/O port 404 may depend upon the configuration of the wired port of the user communication device 800, but in one embodiment, may comprise a USB type C or type A port. In such a configuration, for example, when the user communication device 800 comprises an Apple® iPhone™, a communication cable having an Apple® Lightning™ male connector may be plugged into the communication port 806 of the communication device, and a USB type A or C connector at the opposing end of the cable may be plugged into the first I/O port 404 of the communication device interface 400. Again, it will be appreciated that the configuration of the first I/O port 404 may vary, such as depending upon the configuration of the desired wired communication link between it and the user communication device 800. Further, while in a preferred embodiment, a wired connection, such as a cable, is used to connect the user communication device 800 to the communication device interface 400, other types of direct connections may be used (in some instance, wireless communications may be used if entirely in the secure area). For example, in one configuration, the communication device interface 400 might be configured as a cradle or dock, such as where the I/O port 404 is configured as a male connector that fits directly into the communication port 806 of the user communication device 800. Further, in some embodiments, assuming such is supported by the user communication device 800, even a wireless communication link might be provided between it and the communication device interface 400 (e.g. such as a Wi-Fi connection). In one example embodiment, the communication device interface 400 may facilitate a “casting” function of the user communication device 800. Such a function, which can be facilitated by the AirPlay™ function of an Apple® iPhone™, or is also known as Google® Chromecast™, allows transmission of the video displayed by a user communication device 800 (and associated audio) via a Wi-Fi connection, such as to a wireless communication interface of the communication device interface 400 (or, when functionality of communication device interface 400 is integrated with a first communication isolator 500, as detailed below, to an interface thereof).

The communication device interface 400 preferably also includes other I/O ports, preferably serving as at least one communication interface with the first communication isolator 500. For example, the communication device interface 400 may include a second I/O port 406 and a third I/O port 408. In one preferred embodiment, the second I/O port 406 comprises an interface for visual signals or information and the third I/O port 408 may comprise an interface for other types of data. In such a configuration, the communication device interface 400 may include one or more splitters, processors or the like for separating such information as received from the user communication device 800 and/or for assembling such information (from the first communication isolator 500) for transmission thereto. For example, the second I/O port might comprise an HDMI (or DVI or similar) port, while the third I/O port 408 data might comprise a USB port, such as a USB Type A port.

In some embodiments, the communication device interface 400 is configured to interface with a plurality of different user devices. In such a configuration, the communication interface 400 may be configured as a hub, having multiple I/O ports 404 for connection to different user communication devices 800 and which connect to the one more I/O ports which serve as interfaces to the first communication isolator 500.

As described below, the communication device interface 400 communicates with the first communication isolator 500. The first communication isolator 500 is also located in the non-secure area 300.

In one embodiment, the first communication isolator 500 comprises a housing 502, (which may the same as the housing 402 of the communication device interface 400) one or more communication interfaces or ports for communicating with the communication device interface 400, and one or more communication interfaces or ports for communicating with the second communication isolator 600 (preferably, as described below, via optical communications).

At least one first I/O port is preferably configured to serve as a communication interface with the communication device interface 400. This may comprise a first I/O port 504 and a second I/O port 506. For example, where one of the I/O ports 406 of the communication device interface 400 is a video port (such as an HDMI port), the first I/O port 504 of the first communication isolator 500 may comprise an HDMI input port. Similarly, where another of the I/O ports 408 of the communication interface 400 comprises a USB port, the second I/O port 506 of the first communication isolator 500 may include a corresponding USB port.

Preferably, the communication device interface 400 is communicatively coupled to the first communication isolator 500. For example, an HDMI cable may be placed in communication with the HDMI port 406 of the communication device interface 400 and the HDMI port 504 of the first communication isolator 500.

Most importantly, the first communication isolator 500 is configured to convert signals input thereto from the communication device interface 500 into a non-radio frequency or electrical signal, such as preferably a digital optical signal for transmission to the second communication isolator 600, and to receive such non-radio frequency signals (e.g. digital optical signals) from the second communication isolator 600 and convert them back for transmission to the communication device interface 500. This may be accomplished, for example, by one or more signal processors of the first communication isolator 500 (such as an optical transceiver which converts electrical signals to optical signals (and vice versa)). In this configuration, the first communication isolator 500 has at least one I/O port 508 which comprises a communication interface with the second communication isolator 600. Preferably, this comprises a third I/O port 508 which comprises an optical port, such as in the form of a fiber optic cable port.

The output from the first communication isolator 500 is provided to a first I/O port 602 of the second communication isolator 600 which is located in the secure area 200. When the input is a digital optical signal, the first I/O port 602 is preferably an optical port.

Most importantly, the second communication isolator 600 is configured to process and direct incoming signals to the secure user interface 700. As described below, the second communication isolator 600 is also configured to receive signals, such as inputs, from the secure user interface 700 for routing back to the first communication isolator 500 and thereon to the user’s communication device 800, via the first I/O port 602 thereof as connected to the third I/O port 508 of the first communication isolator 500.

In one preferred embodiment, the secure user interface 700 comprises a plurality of secure input and output devices. In a preferred embodiment, the secure user interface 700 is configured to effectively serve as a secure extension of the user communication device 800—such as by mimicking outputs and inputs that could be provided directly thereto, but permits such to occur relative to a user who is remote from their device. In one embodiment, these devices comprise a touch-screen display 702 which is configured to display information and receive touch inputs from the user, an audio input device such as a microphone 704, an audio output device such as a speaker 706, and in one example, one or more tactile input devices such as a keyboard 708 and a mouse or mouse pad 710.

The touch-screen display 702 is configured to receive a video input from the second communication isolator 600, such as via a video port 604. This port 604 might comprise, for example, an HDMI, DVI or other video port. An HDMI cable or the like may connect the video output port 604 of the second communication isolator 600 to the touch-screen display 702. In one example, the user inputs to the touch-screen display 702 are input to the second communication isolator 600, such as to a first input port 609 thereof. This input port 609 might comprise, for example, a USB port for touch screen capability. In one example, a USB cable which has a 2.0 Micro connector at one end and a USB Type A connector at the other may be utilized between the touch-screen display 702 and the second communication isolator 600, whereby the second communication isolator 600 provides power and touch screen input to the touch-screen display 702.

In a preferred configuration, the touch-screen display 702 does not include additional functionality such as audio in (such as via a microphone), audio out (such as via a speaker), or video in (such as via a camera). Most preferably, this functionality is preferably provided by separate devices having security features as described below.

In one example, audio signals which are received by the second communication isolator 600 are processed and routed to an I/O port 608 which is communicatively coupled to the speaker 706 and microphone 704, such as via a USB 2.0 Type A cable or USB 3.0 Type A depending on the distant end device 800. Audio inputs from the user are captured by the microphone 704 and are routed to the I/O port 608 of the second communication isolator 600.

User inputs to the keyboard 708 are output therefrom to a second input port 610 of the second communication isolator 600, and user inputs to the mouse 710 are output therefrom to a third input port 612 of the second communication isolator 600. These ports might comprise, for example, USB Type A ports for accepting a corresponding connector of a USB cable.

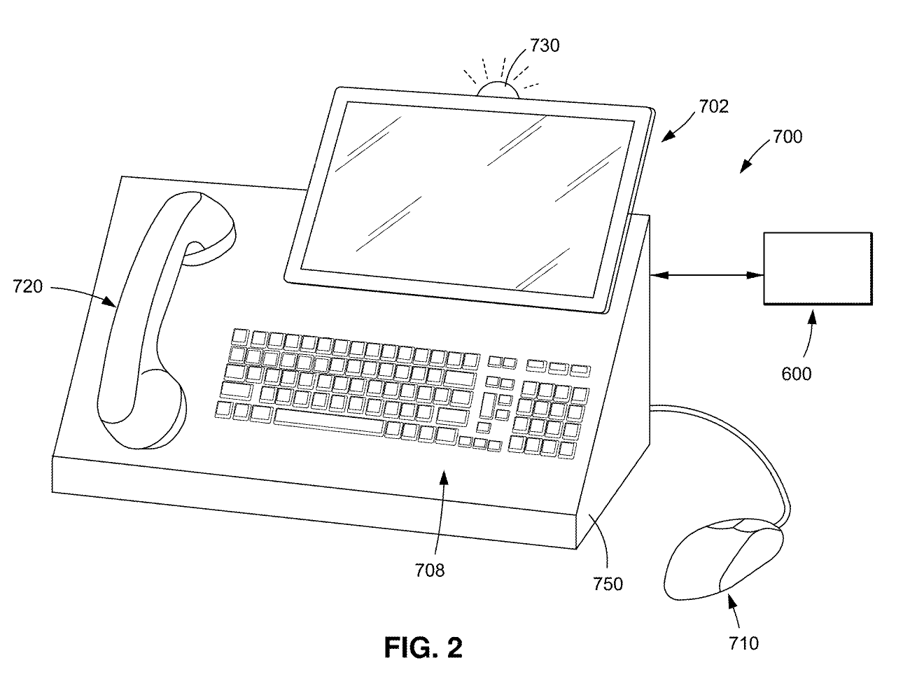

Referring to FIG. 2, in one embodiment, the microphone 704 and speaker 706 may be integrated, such as into a hand or headset 720. Further, as illustrated in FIG. 2, the touch-screen display 702, the handset 720 and keyboard 708 might be integrated into (mounted or set on, connected to, etc.) a base 750 or the like, such as for ergonomics and convenience. In such a configuration, for example, the display 702 might be movably mounted to the base 750, such as to permit it to rotate to various positions (such as various angles of tilt in both the horizontal and vertical), etc. The keyboard 708 might be merely set upon a surface of the base, or it might be mounted into the base 750, such as where the keys extend through a top panel thereof or a keyboard may sit on the desk with the mouse.

In a preferred embodiment, although not shown in detail, power supplies which are used to power the devices in the secure area 200 are isolated from those used to power the devices in the non-secure area 300. Power separation between electrical systems in non-secure area 300 and secure area 200 is preferable. For example, the communication device interface 400 and first communication isolator 500 are preferably powered by one or more first power supplies which are associated with the non-secure area 300. On the other hand, the second communication isolator 600 and the elements of the secure user interface 700 are preferably separately powered, preferably associated with the secure area 200.

General operation of the system 100 will now be described with reference to FIG. 1. A user connects their user communication device 800 to the communication device interface 400 in the non-secure area 300. The user may then enter the secure area 200 without their user communication device 800.

The output of the user communication device 800 is connected to the communication device interface 400, which is in turn routed to the first communication isolator 500 to the second communication isolator 600. The video output of the user communication device 800 is displayed by the touch-screen display 702 and any audio output is output by the speaker 706. In this manner, although the user is located in the secure area 200 and the user communication device 800 is located in the non-secure area 300, the user can see the “display” (e.g. the content which is displayed by) of their device just as if they were looking directly at the video display 804 thereof, and can hear any audio output, such as if they were directly hearing the audio output thereof.

At the same time, the user can interact with their user communication device 800 from within the secure area 200. For example, the user can make touch inputs to the touch-screen display 702 which are routed to the user communication device 800 and provided thereto just as if the user had provided the inputs directly to the display 804 thereof. Further, the user may make other inputs, such as audio inputs via the microphone 704 and/or mouse or keyboard inputs to the mouse 710 and keyboard 708. These inputs are routed through the second communication isolator 600 to the first communication isolator 500 and thereon to the user communication device 800, just as if they were being provided directly to the device 800.

In such a configuration, for example, a user may make and receive telephone calls, read and send text messages, read and send emails, run applications and receive outputs from those applications and make inputs to those applications, etc. For example, a user may input their PIN into the touch-screen display 702 (which is then routed to their user communication device 800) in order to access text, phone, email or other applications and provide inputs thereto. The user’s communication device 800 remains in communication with cellular networks 900 or other networks (such as via Wi-Fi, etc.), such that the user communication device 800 still acts as digital terminal equipment (“DTE”) relative to such communication networks.

At the same time, the user communication device 800 is isolated from the secure area 200 in a manner which solves the problems which are described herein. In particular, the portion of the system 100 which is located in the secure area 200, including the second communication isolator 600 and the secure user interface 700, are components which do not emit wireless signals, such as radio frequency signals. Further, the user communication device 800 is located in the non-secure area 300, so any bugs or the like which might be associated therewith do not influence the secure area 200.

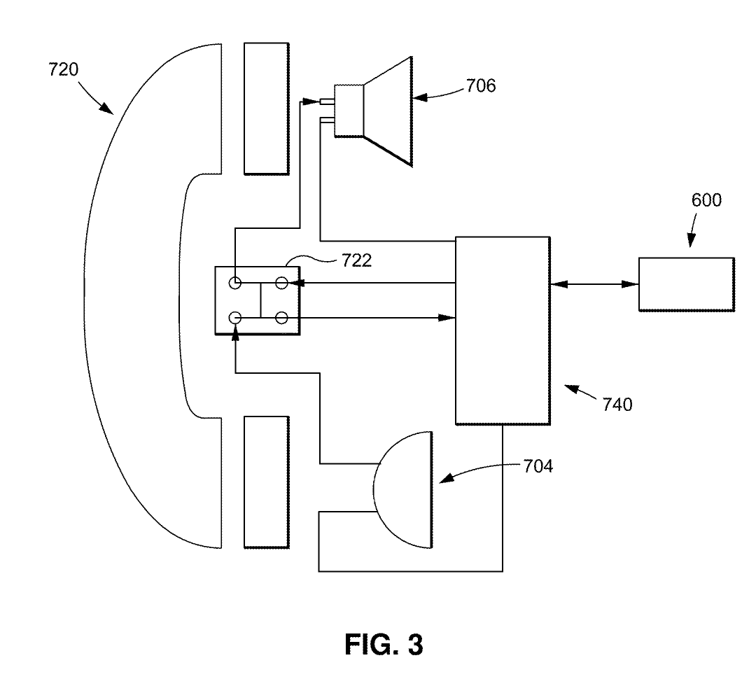

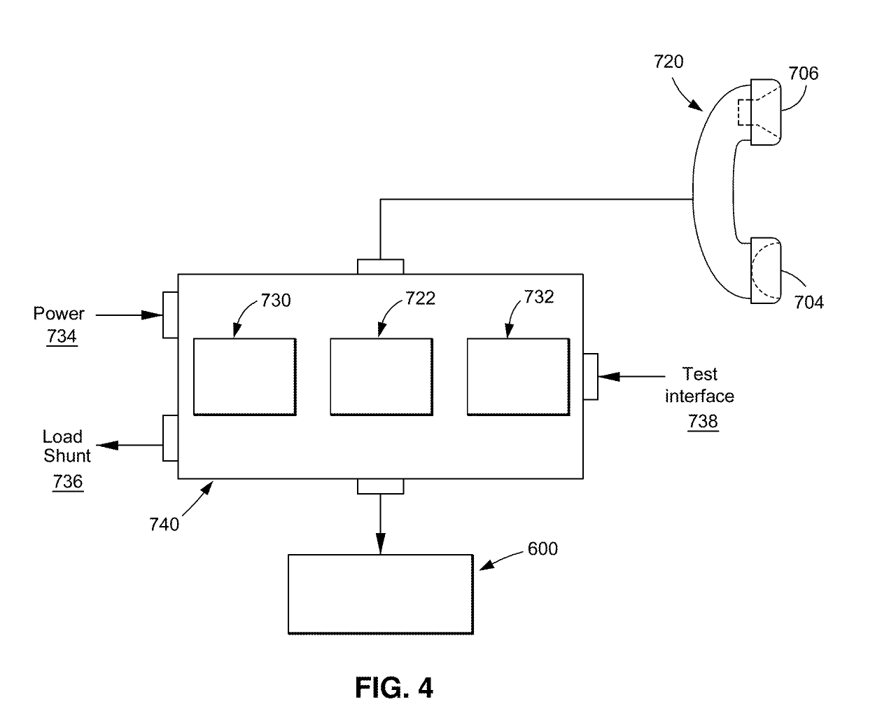

Additional aspects of the invention will be described with reference to FIGS. 3 and 4.

In one embodiment, the system 100 may include other security features. For example, in one configuration, means may be provided for positively connecting and disconnecting the microphone 704 and/or speaker 706.

As one example, as illustrated in FIG. 3, a switch 722 may be associated with the hand or headset 720. This switch 722 may have a first position or mode in which the communication pathway to the second communication isolator 600 is open or incomplete, wherein no communication signals pass between the speaker 706 and microphone 704 and the second communication isolator 600, and a second position or mode in which that communication pathway is closed or complete. In one embodiment, the switch 722 might be associated with the handset 720, such as having a button on the handset 720 which can be manually actuated (such as pressed) to move it from the first position (such as biased to that position) to the second position. In this manner, when a user wishes to use the microphone 704 and/or speaker 706 portions of the secure user interface 700, the user must activate or engage the switch (such as by holding and depressing the switch during the time the user wishes to have the handset 720 be active), and preferably where that switch moves back to the first position when not engaged. This “positive engagement” aspect of the invention reduces the opportunity for the microphone and/or speaker to be used nefariously, such as to listen to sounds in the secure area 200 when it is not being used such as via hacking or bugging of the communications device 800.

Of course, this concept might be applied to other input or output devices of the secure user interface. In some embodiments, more than one switch might be provided, such as one corresponding to the microphone and one corresponding to the speaker.

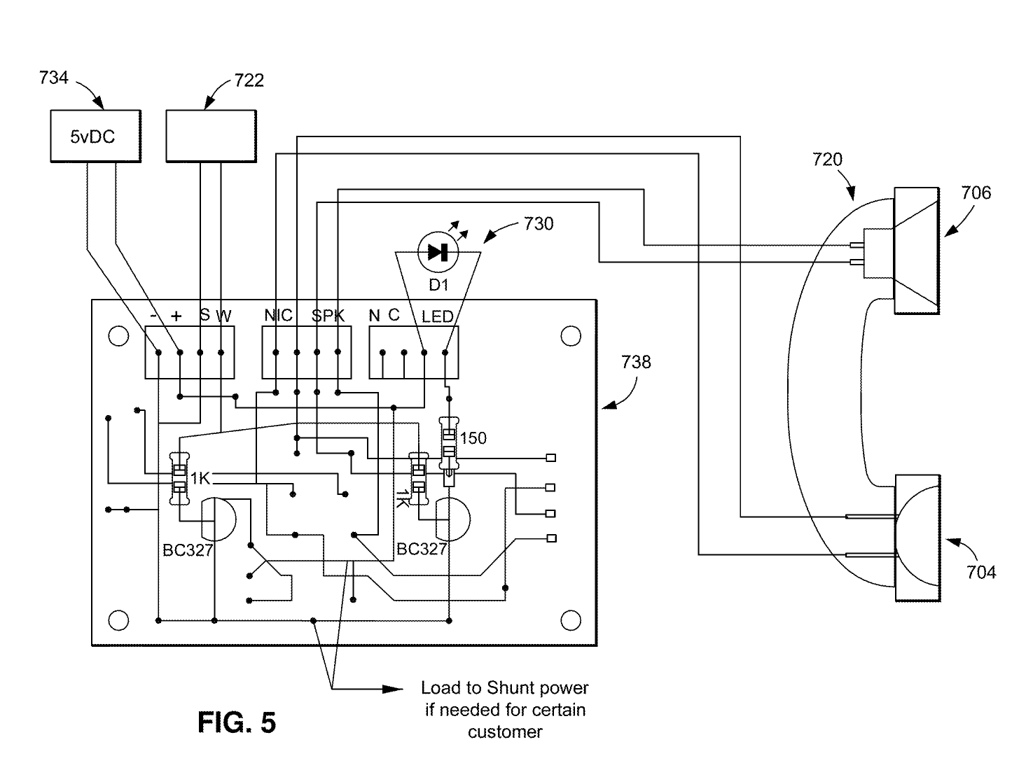

FIGS. 4 and 5 illustrates another configuration of the invention. As illustrated in FIG. 4, a handset module 740 may comprise the switch 722, one or more illumination devices or lights 730, and at least one audible emitter 732, such as a ringer or buzzer. This module 740 may be located between the handset 720 and the second communication isolator 600. The switch 722 may have similar functionality to that described above and might comprise a push-to-talk type button or switch. However, in another configuration, the switch 722 may be integrated into a base station or the like which accepts the handset 720 when not in use. When the handset 720 is not in use it may be placed on a portion of the switch 722 that causes the switch to move to an open position, thereby disconnecting the handset 720 from operation, and wherein when a user lifts the handset 720, the switch moves to a closed position, thereby rendering the handset 720 operable (e.g. placing it in communication with the second communication isolator 600) and lighting an LED “730” indicating it is off hook.

In one embodiment, the light 730 may illuminate to indicate when the handset 720 is operable. Thus, the light 730 may illuminate when the switch 722 is closed. As illustrated in FIG. 2, the light 730 may be associated with the base 750, such as by being located at an elevated or visible portion thereof, such as at the top of the display 702. In this manner, those in the vicinity of the secure user interface 700 can be visually warned when it is active.

In one embodiment, the buzzer or ringer 732, and/or one or more lights (such as the same as, or different from the light 730 which is used to indicated whether the handset is in use) may be configured to activate when an incoming signal is received by the user communication device 800 and is routed to the second communication isolator 600, such as to alert a user of the secure user interface 700 that a call, text, email or other communication has been received by the user communication device 800 and may require a response.

In some embodiments, the secure user interface 700 (such as the handset module 740) may include or implement an audible alert mechanism. This mechanism may be configured to detect an incoming ring signal from the second communication isolator 600 (such as output therefrom via a USB or 3.5mm audio channel port), and may include an amplifier circuit that generates an enhanced output (such as a higher voltage electrical output) that energizes a buzzer and/or light indicator when a ring voltage is detected (thereby providing an audible and/or visual notification in the secure area of an incoming call or communication), and/or may include a relay that disables the alert mechanism when the handset is off-hook to prevent false alerts during active calls.

In some embodiments, the secure user interface 700 includes low-voltage output terminals for integration with sensitive compartmented information facility (SCIF) or other secure area strobe lighting (or other) systems, where the interface 700 activates the output upon handset off-hook status or push-to-talk activation to provide non-intrusive, visual notifications via the SCIF strobe lighting system.

As illustrated in FIG. 4, the handset module 740 may have a power input 734, and might include other features, such as a load shunt 736 and technical security test interface 738.

FIG. 5 illustrates one example implementation of the handset module 740, wherein elements of the module 740 are associated with a circuit board.

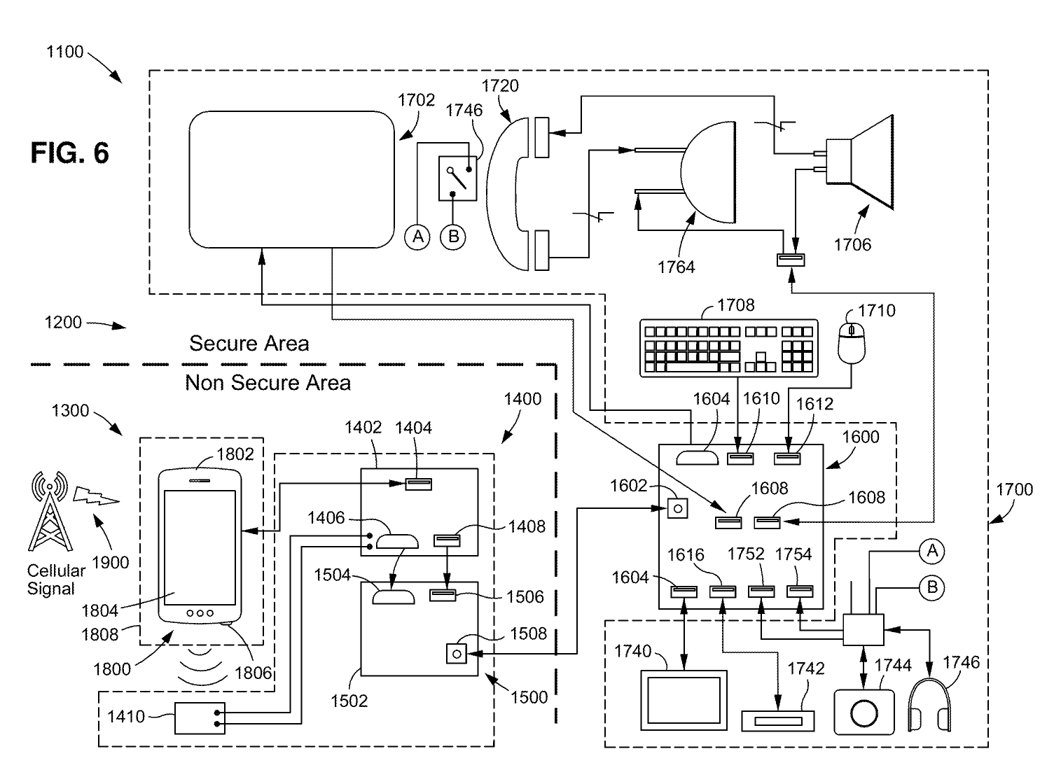

Additional aspects of the invention will be described with reference to FIG. 6. FIG. 6 illustrates another embodiment of a system 1100 which is similar to the system 100 described above and illustrated in FIG. 1, and wherein like elements have been given like reference numbers to the elements in FIG. 1. It will be appreciated that various features of this system 1100 might be implemented relative to the system 100 described above.

As illustrated in FIG. 6, as one aspect of the invention, the user communication device 1800 might be stored in a storage element 1808 within the non-secure area 1300. The storage element 1808 might comprise, for example, a container which has controlled access. For example, the container might define one or more storages areas, where each storage area is accessible via a door which may be lock controlled (such as via a mechanical lock such as which may be key-actuated, an electro-mechanical lock which might be controlled by a controller and motor, such as based upon input of an access code to a keypad or other device, etc.). The container might be constructed from a generally opaque material (such as Plexiglass, etc.) or the like to impede people from viewing the device in the non-secure area while active. Importantly, the storage element 1808 allows wireless communications with a user communication device 1800 which is associated therewith (e.g. is not constructed in a manner which causes it to interfere with, such as block, such signals).

In one embodiment, power may be provided to the one or more storage areas, such as via a charging port (such as a USB port, electrical outlet, USB cable or the like), thus allowing a user communication device 1800 which is stored in the storage area to be provided with power. In use, a user may open a storage area, connect their device to the data connection which also provides power, and place their device in communication with the communication device interface 1400, and then lock the storage area to protect their device from theft/loss, etc., such as while they are in the secure area 1200.

As indicated above, the communication device interface 1400 may be configured to communicate with the user communication device via a wired link via a communication port 1404, such as described above, or in other examples, via a wireless communication link. In one embodiment, for example, the communication device interface 1400 may be configured to receive information/data from a wireless communication interface 1410 and be configured to transmit information/data thereto. The wireless communication interface 1410 may comprise, for example, a Bluetooth™ wireless communication interface which is configured to communicate with a similar interface of the user communication device 1800. In one embodiment, the wireless communication interface 1410 may be configured to convert the wireless signals received from the user communication device 1800 to a wired output, such as a 3.5mm audio output which is provided to a mating port of the communication device interface 1400. Likewise, the communication device interface 1400 may include a similar audio output port over which audio may be transmitted to the wireless communication device interface 1410 for conversion to a wireless signal and transmission to the user communication device 1800. Of course, the wireless communication interface might be integrated into the communication device interface 1400. In other embodiments, the wireless communication interface 1410 might comprise a wireless communication dongle, such as which is plugged into a USB or other port of communication device interface 1400.

Once again, the information/data provided to the communication device interface 1400 from the wireless communication interface 1410 is preferably provided to the first communication isolator 1500, such as via corresponding communication ports, or via inclusion in other outputs of the communication device interface 1400 (such as via the signals which are output via the first or second I/O ports 1504, 1506, etc.). As described below, this arrangement facilitates communication to and from the user communication device 1800 when that device may output signals in different manners (such as via wired vs. wireless communications in different scenarios).

As further illustrated in FIG. 6, the secure user interface 1700 may include additional features. For example, the second communication isolator 1600 may include one or more additional video output (or I/O) ports 1604 (such as an HDMI, DVI port, etc.), such as for providing an additional video output therefrom (of the video portion of the signal/data received by the second communication isolator 1600 from the user communication device 1800) to a secondary video display (1740) (such as over an associated HDMI, DVI or other cable/communication link).

The secure user interface 1700 might also include other input and/or output ports, such as for receiving information from or providing information to other devices. For example, the secure user interface 1700 might include a peripheral I/O port 1616, such as a USB port, for communication with a card reader device 1742, such as which may be configured to read a user identity or access card, including key data (such as a public or private access key) stored in association with the card (such as on a magnetic strip, chip, readable code, etc.).

In addition, the secure user interface 1700 may include one or more of an image capture device or camera 1744 and/or a headset 1746 (such as headphones and/or a microphone). An output of the camera 1744 may be provided to the second communication isolator 1600 via an input port 1752 (such as a USB port), and outputs to and inputs from the headset 1746 may be provided to and from the second communication isolator 1600 via an I/O port 1754 (such as a USB port; or via separate input and output ports).

In one configuration, a positive disconnect switch 1746 (similar to the switch 722 described relative to the handset 720 in FIG. 3), may be provided to selectively enable and disable operation of the camera 1744 and/or headset 1746. An input to the camera 1744 (such as an image of a user’s face) may be utilized, for example, as an input to the user’s communication device 1800 in order to validate the user and use of the user’s communication device 1800 and/or applications running thereon.

In one embodiment, the secure user interface 700/1700 may be configured to, or permit, transmission of an input to the user communication device 800/1800, which dictates the orientation of the information displayed by the user communication device, and thus on the one or more video displays of the secure user interface. For example, a user input or a circuit/control input may be implemented by the secure user interface 700/1700 to the user communication device 800/1800, such as to force the user communication device into “landscape” display mode, which then correspondingly causes the information displayed thereby to be displayed in the same orientation on the one or more displays of the secure user interface 700/1700. In other embodiments, the secure user interface 700/1700 might include a “rotate” function which allows information which is output by the user communication device 800/1800 to be rotated into a desired orientation for display by the one or more video displays thereof.

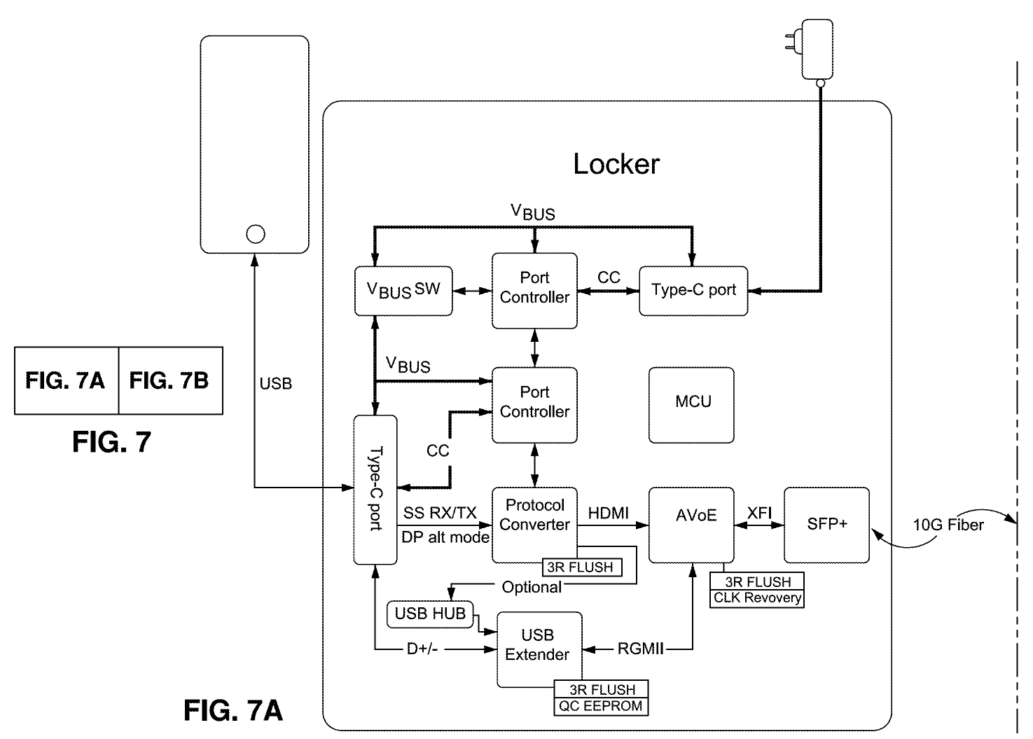

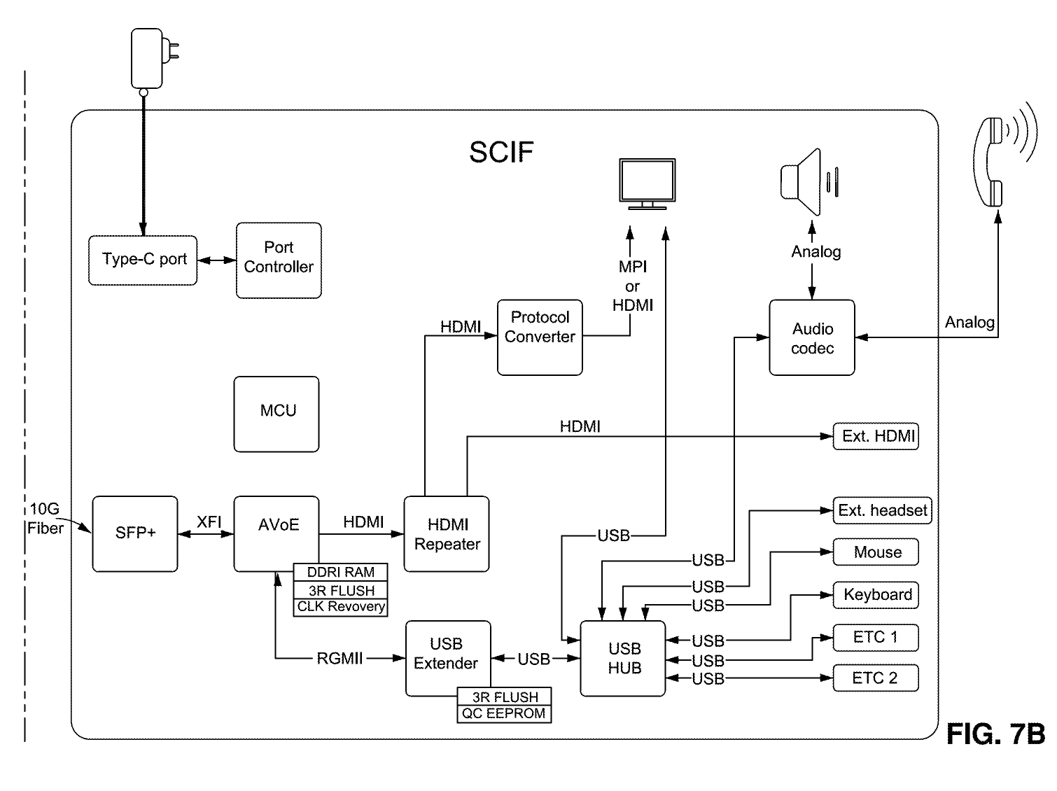

In examples of the invention, certain configurations and combinations of communication ports or interfaces have been described. It will be appreciated that other configurations or combinations of such ports/interfaces might be utilized. For example, instead of the first communication isolator 500/1500 and second communication isolator 600/1600 communicating via connected I/O optical ports, the first and second communication isolators 500/1500, 600/1600 might each have one optical output port and one optical input port, whereby the input and output interfaces are separated. In general, different numbers of ports or interfaces might be utilized, such as depending upon whether signals are combined or separately transmitted or by the manufactured configuration of the communications device 800/1800. FIGS. 7A and 7B illustrate one example implementation of the invention. FIG. 7A illustrates a storage element (such as in the form of a locker having a plurality of lockable storage locations) for a plurality of user communication devices, where that storage element has an integrated communication device interface and first communication isolator, such as for location in an unsecure area. FIG. 7B illustrates a secure user interface for location in a secure area, which includes a second communication isolator (which is in communication with the first communication isolator illustrated in FIG. 7A) and which includes a plurality of secure user input and output devices. It will be appreciated from FIGS. 7A and 7B that many particular implementations of the present invention may be enabled.

In addition, the invention may be configured to not only isolate a user’s cellular communication device (and enable secure communications therewith), but also enable secure communications with wired communication devices (such as traditional telephones) or voice over IP (VOIP) devices. For example, the communication device interface 400/1400 might include an RJ11, RJ45 and/or RJ12 interface for a telecommunication device cord and might transmit the signals provided thereover to the first communication isolator 500/1500 for processing and transmission to the second communication isolator 600/1600 (and vice versa, relative to signals provided from the second communication isolator 600/1600 to the first communication isolator 500/1500).

It will be appreciated that the invention might also serve as a secure computing interface, such as to remote computers, including servers hosting data or applications. In particular, elements of the secure user interface 700/1700, such as the keyboard, mouse and display, effectively serve as user interfaces to such remote devices. For example, the communication device interface 400/1400 might further include an RJ45 or similar port for an associated cable, such as for receiving and transmitting digital data, such as to a remote computer, such as via a network (LAN/WAN), the Internet or the like.

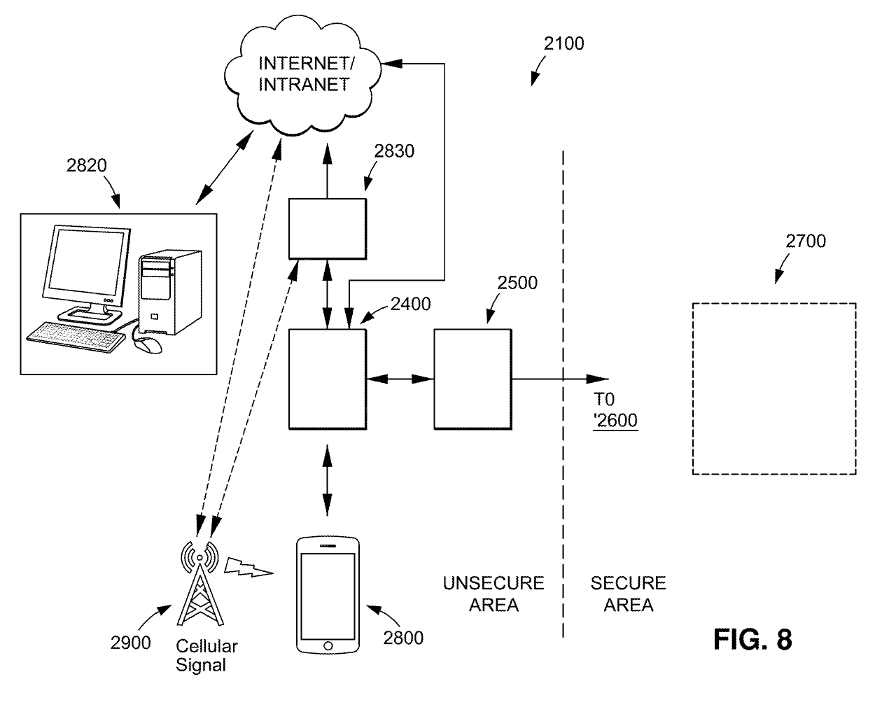

For example, FIG. 8 illustrates additional aspects of the invention in the form of a system 2100 which is similar to the systems 100, 1100 described above and illustrated in FIGS. 1 and 6, and wherein like elements have been given like reference numbers to the elements therein. It will be appreciated that various features of this system 2100 might be implemented relative to the systems 100, 1100 described above.

As noted above, the invention may enable secure communications between a secure user interface 2700 and one or more remote (e.g. outside of the secure area) networks and devices, such as a remote computing device 2820. Such a computing device 2820 may be communicatively coupled to the Internet or Intranet (including by one or more intermediary networks including LANs and WANs), including by wired or wireless communication links. The computing device 2820 may comprise, but is not limited to a desktop computer, a laptop computer, a workstation, a tablet, a server or other devices having a communication device and a processor which is configured to execute machine-readable code that may be stored in non-transitory form in a memory or which is implemented by a dedicated processor (e.g. in the form of circuitry).

In one embodiment, communications may be facilitated between the remote computing device 2820 and the secure user interface 2700 via a communication device interface 2400 and first and second secure communication isolators 2500/2600, similar to that described above.

In one embodiment, a user communication device 2800 may serve as an interface to the remote computing device 2820. For example, data may be exchanged between the user communication device 2800 and the remote computing device 2820 via a wireless communication link with a wireless communication network 2900 which is linked to the Internet/Intranet, and thus the remote computing device 2820. In other embodiments, data may be exchanged between the user communication device 2800 and the remote computing device 2820 via a wired communication link to the Internet/Intranet. As one example, the user communication device 2800 might be connected to an RJ45 port (such as associated with the communication device interface 2400), which port connects to a communication link to the Internet/Intranet. For example, in one embodiment, the user communication device 2800 may be communicatively coupled to the communication device interface 2400 in one of the manners described above. The communication device interface 2400 may, in turn, include an RJ45 port to which is connected an Ethernet cable that is linked to a communication link (hub, router, etc.) that supports communications to the Internet/Intranet. In other configurations, the user communication device 2800 might on the one hand be connected to such a wired communication link (for example, in the case of an Apple® iPhone™ communication device, via an Apple® Lightning™ to Ethernet adaptor which is engaged with the wired communication port of the device and extends to and is communicatively coupled to the communication device interface 2400 (whereby communications thus pass from the secure area through the user communication device 2800 to the wired communication link and on to the remote device/network, and from such remote device/network via such wired link via the user communication device 2800 to the secure area).

One advantage of this configuration is that communications with external networks and devices are enabled by multiple pathways via the user communication device 2800, including cellular data/networks, WiFi, and wired communication pathways. For example, in some instances, connection of a user’s communication device 2800 to a cellular network or using WiFi may either not be possible or permissible. For example, in some locations, cellular networks may not be available and no WiFi network capability may be supported or permitted. In such event, the user communication device 2800 can be linked via a wired connection such as described above, to one or more devices or networks. Such a connection allows, for example, a data (including VoIP) link to the user communication device 2800. As one example, the wired data link on to the user communication device 2800 may be associated with a PBX or VoIP system, thus enabling connection of the user communication device 2800 to such voice-call handling systems. As one example, a user in the secure area might call a remote user who is using a handset on a remote PBX system from the secure user interface 2700 as linked to the user communication device 2800 which is, in turn, communicatively coupled to the remote user’s device via the PBX system.

It will be appreciated that in some instance, access to remote computing devices or systems may require user authentication. As noted above, a user might provide an input of a PIN, a password or the like to one of the input devices of the secure user interface 2700 (such as a touch-screen or keyboard). However, other types of authentication might be used and supported. For example, a user may be required to provide a validation card. Information associated with the card might be read by a scanner or card reader (such as card reader 1742 in FIG. 6, such as a via an optical reader, magnetic stripe reader or the like) and be transmitted via the system 2100 to the remote network or computing device 2820 for validation, such as to permit communications with the remote computing device.

Other features and variations of the disclosed concepts are possible.

As one aspect of the disclosure, the system may implement and/or integrate location obfuscation technology. For example, the system may implement GPS spoofing in relation to the user communication device and/or data source/location obfuscation. As one example, as detailed above and with reference to FIG. 8, outbound communications may be routed via the user communication device 2800 to other devices and systems on the unsecure side via a secondary device 2830. The secondary device 2830 might, for example, comprise a computing device (such as with a processor which is configured to execute machine readable code or instructions which are stored in non-transitory form in an associated memory and which is executable by the processor, or with custom configured circuitry) with a cellular communication interface, where the secondary device 2830 is configured to implement GPS spoofing or similar technology. In such a configuration, any cellular communication signals transmitted by the secondary device 2830 may include modified GPS location data or cause the cellular network 2900 to designate the secondary device 2830 as having a determined location which is different than the physical location of the secondary device 2830.

As another example, the secondary device 2830 may be configured to implement a virtual private network (VPN), such as by the secondary device 2830 creating a VPN client as part of a communication link between the user communication device 2800 and an external server, through which outbound data is routed, causing the data to appear to emanate from a location other than the secondary device 2830 and/or the user communication device 2800. In some instances, the secondary device 2830 may also implement VPN obfuscation technology, such as to mask to third parties that the data is being routed via a VPN.

In some cases, the user communication device 2800 might be configured to implement the location obfuscation technology, such as by running an application which implements GPS spoofing or VPN technology. An advantage to the configuration which is illustrated in FIG. 8 is that the outbound communications of multiple user communication devices (such as where user communication devices are located in banks of lockers) may all be routed through one or more secondary devices 2830 that implement this functionality relative to all of the user communication devices.

Systems and methods of the disclosure may implement or enable additional security features or functionality. As one example, the system may be configured so that any signals present within the transmission path, including residual electrical noise, electromagnetic emissions, or optical artifacts, contain no embedded intelligence, recoverable data, or interpretable information content. In one embodiment, this characteristic may be enabled by a configuration in which no component within the secure-side system stores or processes user data in a recoverable or interpretable form, and any signal handling is limited to deterministic, fixed-function operations that do not encode or reconstruct user information As one example, the system eliminates all processing, encoding, modulation, or packetization functions that operate on or transform user data within the secure-side (200, 1200) hardware, such as the components of the secure user interface 700, 1700, 2700 and the second communication isolator 600, 1600, 2600 (whereby the components on the secure side are incapable of producing emissions that are mathematically correlated/correlatable to user data), while permitting fixed-function or device-level signal handling that does not reconstruct, interprets or store user data in a recoverable form.

The signal paths from the components of the secure user interface 700, 1700, 2700 through the second communication isolator 700, 1700, 2700 to the first communication isolator 500, 1500, 2500 may be implemented as a deterministic, analog or direct-mapped interface that does not introduce, alter, or reconstruct data beyond pass-through signal conveyance (for example, the transmitted optical signals lack information-bearing noise and are not modulated in a manner that encodes user data, and are then directly converted to electrical signals via an optical transceiver without processing (modifying/altering) the signal). As a result, any incidental noise or emissions generated by those elements of the system are inherently non-informational and cannot be exploited to reconstruct user data, application content, or communication signals. This characteristic distinguishes the system from conventional computing or communication devices, where noise may correlate with processed or encoded data streams.

In some implementations, the absence of intelligence in system noise is further ensured by: (a) the lack of firmware, operating systems, or programmable processing elements capable of processing/storing user data with system components within the secure area, (2) the absence of memory or data retention mechanisms capable of storing, reconstructing or interpreting user data or communication content within the system components in the secure area (wherein any memory or buffering present in such components is limited to transient, non-addressable storage used for signal handling or device operation and does not permit retention or recovery of user data), (3) the use of unidirectional or physically isolated transmission media (e.g., optical fiber) that prevent signal regeneration or interpretation within the secure area, (4) signal generation and transmission in a manner in which the signals/data re not packetized, encoded, compressed or digitally reconstructed, and/or (5) hardware-level isolation techniques that prevent coupling between data-bearing signals and any observable emissions.

Accordingly, any incidental noise or emissions generated by the system are non-informational and not correlated to user data , thereby mitigating side-channel, TEMPEST, and emanation-based exfiltration risks. The system architecture ensures that any measurable emissions or noise do not carry red-side intelligence, as there is no transformation, encoding, or computation occurring within the secure boundary that could imprint information onto such emissions. Consequently, the system inherently limits compromising emanations to non-informational artifacts.

As indicated above, in one embodiment the secure user interface 700/1700 preferably includes a keyboard 708/1708 and a mouse 710/1710. As indicated, these devices may be communicatively coupled to the second communication isolator 600/1600. In some embodiments, such a connection may be by a USB connection. However, in a preferred embodiment, such communication connections are preferably either integrated (e.g. direct, without the user being able to associate different devices with the communication path, such as not including a USB port which allows the user to connect different devices to the second communication isolator 600/1600), or are implemented as non-enumerating, device-type interfaces (as opposed to device class), wherein such interfaces (e.g., PS/2) utilize deterministic command-response protocols that restrict connected devices to predefined functional roles and prevent dynamic device classification, composite functionality or arbitrary data transfer. In contrast to class-enumerating interfaces such as USB, which permit dynamic device role assignment and support multiple device classes including audio and storage, the use of non-enumerating interfaces ensures that only predefined input devices may operate within the secure area, thereby eliminating classes of exfiltration pathways associated with peripheral substitution. For example, in one embodiment, the communication ports 610/1610 and 612/1612 are PS/2 type communication ports which are configured to utilize a command-response protocol and receive a device identification from the associated device (such as keyboard or mouse), rather than USB. This prevents, for example, a user from associating a USB microphone, speaker or other audio device with the communication port which, if the port were a USB port, would cause, due to the USB class enumeration processing of the peripheral, that peripheral to be enumerated as the audio device for the secure user interface 700/1700, thus bypassing the handset 720/1720, and the security features thereof (such as the push to talk switch). This configuration prevents introduction of unauthorized peripheral capabilities, including audio input/output devices, data storage devices, or network-capable interfaces, which could otherwise bypass security-controlled signal paths (in certain embodiments, any interface circuitry utilizing class-enumerating protocols (e.g., USB) is not exposed to the user within the secure area and is not accessible for connection of peripheral devices and such circuitry, if present, is limited to internal system operation and does not permit user-driven device substitution, enumeration, or arbitrary data transfer).

As another example, the communication device interface 400/1400/2400 and first communication isolator 500/1500/2500 might be integrated, such as into a single unit. In such a configuration, the functionality thereof may be combined. As one example, in such a configuration, the first I/O port 404/1404 of the communication device interface 400/1400 might comprise a first I/O port to a single module, where inputs thereto are processed and transmitted to an optical I/O port that is connected to the second communication isolator 600/1600 (so that the intermediate connections between the communication device interface 400/1400 and the first communication isolator 500/1500 are effectively eliminated, such as by integration).

Also, while the term “port” herein may comprise a female receiver or socket, such as for receiving a corresponding male connector, or having other configurations which readily permit connection and disconnection of elements, in various configurations the ports may simply comprise interfaces and those interfaces may or may not permit ready coupling/de-coupling or connection/disconnection.

One advantage to the configuration illustrated in FIG. 6 is that it facilitates use of devices where the source of the audio may result in a different output for the audio or a combination of two separate voice channels on the same device. For example, some user communication devices 800/1800 process audio differently, depending upon the source of the audio. For example, in some configurations, a user communications device 800/1800 may output audio via a wired output (such as the wired Lightning™ port of Apple® devices) and via a wireless (such as via Bluetooth™) interface. The configuration illustrated in FIG. 6 and as described above, is compatible with such a configuration, in that when the audio is output via the wired port, the audio and any associated video may be captured and routed to the first I/O port 1404, whereas when the audio is output via the wireless interface, the audio may be captured by the wireless interface 1410 and routed to the communication device interface 1400 and any video may be captured via the wired interface and also routed to the communication device interface 1400 (and vice versa).

In addition, the invention permits a wide range of user devices, such as a smart phones having different configurations and operating systems, which are located in the non-secure area, to be connected through mirroring technology to wirelessly transmit video and/or audio (such as via a wireless interface, such as a dongle, as described above), via the first and second communication isolators to a user interface in a secure area. In such a configuration, other inputs and outputs between the user device in the non-secure area and the user interface in the secure area (such as keyboard, mouse and other inputs) can be exchanged via wired connections which are exchanged through the communication isolators.

Additional aspects of the invention comprise methods of facilitating secure communications to and from a user in a secure area, including but not limited to methods of utilizing a system of the invention.

In one embodiment, a method of facilitating secure communications to a user in a secure area via an unsecured user communication device is provided. In accordance with the method, at least one output of a user communication device located outside of the secure area is received. This output may comprise a wired or wireless output comprising video, audio and/or other data. In one embodiment, this step may comprise communicatively linking the user communication device with a communication interface, such as via one or more wireless and/or wired communication links.

In accordance with the method, electrical signals comprising the output of the user communication device are converted to one or more optical signals outside of the secure area, such as via a first communication isolator located outside of the secure area.

The one or more optical signals are transmitted from outside of the secure area to inside of the secure area, such as via one or more optical transmission paths, such as optical fiber. The one or more optical signals are converted to one or more input signals to one or more user devices of a secure user interface, such as via a second communication isolator located in the secure area. The one or more input signals are used to present audio, visual or other information to the user via the devices of the secure user interface, such as video information on a video display and audio information via a handset or speaker.

Another embodiment of a method of the invention comprises facilitating secure communications from a user in a secure area via an unsecured user communication device. In accordance with the method, inputs are received from the user in the secure area to one or more user input devices of a secure communication interface. These inputs may comprise, for example, inputs to a keyboard, touch screen, camera, microphone, card reader or the like. These user inputs are converted to optical signals in the secure area, such as at a second communication isolator, and are then transmitted from the secure area to an unsecure area, such as via one or more optical communication paths to a first communication isolator in the unsecure area. The one or more optical signals are then converted to electrical signals and are provided to a user communication device. In one embodiment, the first communication isolator converts the optical signals to one or more electrical signals, outputs those one or more signals to a communication interface in the unsecured area, and then further outputting those signals from the communication interface to the user communication device, such as via one or more wired or wireless communication interfaces.

As one aspect of the invention, restriction of all secure-side user-accessible interfaces to deterministic, fixed-function communication protocols and eliminating any capability to store, reconstruct, or interpret user data within the secure area, the system ensures that any emissions or noise generated are inherently non-informational and not correlated to user activity, providing enhanced data/information security.

Additional aspects of the method may comprise disconnecting one or more elements of the secure communication interface when not in use, such as disconnecting them from the second communication isolator. In one embodiment, one or more alerts, such as visual or audio, may be indicated in the secure area in response to an incoming communication from the user communication device.

Aspects of the method apply to communications to and/or from a user in a secure area with devices other than a user wireless communication device, such as a computing device, telephone or other communications or computing device which is located in an unsecure area.

It will be understood that the above-described arrangements of apparatus and the method there from are merely illustrative of applications of the principles of this invention and many other embodiments and modifications may be made without departing from the spirit and scope of the invention as defined in the claims.

What is claimed is:

1. A system facilitating secure communications with a user communication device from a secure area comprising:
a first communication isolator for location in said unsecure area, said first communication isolator comprising a first communication port for connection to a communication port of said user communication device, a second wired communication port for wired communication coupling said user communication device to at least one third party system or device via said first communication port, and at least one optical communication port;
a second communication isolator for location in a secure area, said second communication isolator comprising at least one optical communication port for connection to said at least one optical communication port of said first communication port to permit communications between said first and second communication isolators via a secure optical communications channel, said second communication isolator further comprising at least one user interface communication port; and
a secure user interface for location in said secure area, said secure user interface comprising at least one communication port for connection to said at least one user interface communication port of said second communication isolator, said secure user interface comprising a video display having touch input, at least one speaker and at least one microphone;
whereby outbound communications based upon user inputs to said secure user interface are transmitted to said at least one third party system or device via the secure optical communications channel and said user communication device and inbound communications from said at least one third party system or device are transmitted to said secure user interface via said user communication device and said secure optional communications channel.

2. The system in accordance with claim 1, wherein said secure user interface further comprises a media reader configured to read data associated with a media.

3. The system in accordance with claim 1, wherein said media reader comprises a card reader for reading authorization information associated with a presented card and routing to third party device or system via said user communication device.

4. The system in accordance with claim 1, further comprising at least one computing device having a communication interface coupled by a first wired communication link to said second wired communication port of said first communication isolator and a second communication link to said at least one third party system or device.

5. The system in accordance with claim 4, wherein said computing device comprises a processor, a memory and machine-readable instructions stored in said memory and executable by said processor to cause said processor to implement a virtual private network client associated with a virtual private network over which said outbound and inbound communications are routed.

6. The system in accordance with claim 4, wherein said computing device comprises a processor, a memory and machine-readable instructions stored in said memory and executable by said processor to cause said processor to alter geo-location information associated with said outbound communications.

7. The system in accordance with claim 1, wherein said secure user interface does not include any user accessible class enumerating communication ports.

8. The system in accordance with claim 7, wherein said secure user interface comprises at least one PS/2 communication port.

9. The system in accordance with claim 8, wherein said PS/2 communication port utilizes a deterministic command-response protocol that restricts communication to predefined input signaling and prevents transmission of arbitrary data streams or device role reassignment”

10. The system in accordance with claim 1, wherein said at least one third party system or device comprises a PBX or voice over IP communication system.

11. The system in accordance with claim 1, wherein said secure user interface comprises an integrated unit comprising a housing supporting said video display and a handset, wherein said at least one speaker and said at least one microphone are associated with said handset.

12. The system in accordance with claim 11, wherein a keyboard is connected to said housing.

13. A method of facilitating secure communications to and from at least one third party system or device outside of a secure area and a user in a secure area via a user communication device outside of the secure area, comprising the steps of:
receiving, at a first communication isolator located outside of said secure area, an inbound communication from said at least one third party system or device via said user communication device;
converting said inbound communication to at least one first optical signal;
transmitting said at least one first optical signal from said first communication isolator to a second communication isolator located in said secure area via at least one optical communication link;
presenting said inbound communication via a user interface located in said secure area and communicatively coupled to said second communication isolator;
receiving an outbound communication based upon one or more user inputs to said user interface at said second communication isolator;
converting said outbound communication to at least one second optical signal;
transmitting said at least one second optical signal from said second communication isolator to said first communication isolator via said at least one optical communication link; and
transmitting said outbound communication to said at least one third party device or system via said user communication device located outside of said secure area.

14. The method in accordance with claim 13, wherein said outbound communication is transmitted via a VPN.

15. The method in accordance with claim 13, further comprising the step of associating modified geo-location data with said transmitted outbound communication.

16. The method in accordance with claim 13, wherein said outbound communication is transmitted via a wired Ethernet communication link.

17. The method in accordance with claim 13, wherein any electrical, optical, or electromagnetic noise generated by said user interface and associated second communication isolator within said secure area contains no recoverable, encoded, or interpretable information corresponding to said outbound communication or inbound communication.

18. The method in accordance with claim 13, wherein said second communication isolator and said user interface in said secure area does not generate or output signals which are packetized, encoded, compressed, or digitally reconstructed.

19. The method in accordance with claim 13, wherein said user interface comprises at least one video display and at least one audio output device and said step of presenting comprises displaying any video content represented by said inbound communication via said at least one video display and presenting any audio represented by said inbound communication via said at least one audio output device.

20. The method in accordance with claim 13, further comprising these step of providing, by at least one indicator in said secure area, an indication of an incoming communication.
